(19) United States
(12) Patent Application Publication
(10) Pub. No.: US 2008/0247807 A1
(43) Pub. Date: Oct. 9, 2008

(54) Liquid dispensing instrument

(76) Inventors: William P. Whitehorn, Yardley, PA (US); Michael Blackburn, New Jersey, NJ (US); Paul Dowd, Bronxville, NY (US)

Correspondence Address: PAUL, HASTINGS, JANOFSKY & WALKER LLP, 875 15th Street, NW, Washington, DC, 20005, US

(21) Appl. No.: 11/604,759

(22) Filed: Nov. 28, 2006

Related U.S. Application Data
(60) Provisional application No. 60/740,240, filed on Nov. 29, 2005.

(51) Int. Cl. B43K 5/00

(52) U.S. Cl. 401/205

(57) ABSTRACT

A liquid dispensing instrument, such as a marker assembly, the instrument having a barrel, a release mechanism, and a cap. The release mechanism can comprise a deformable arm affixed to the barrel or the cap, for pushing the cap and barrel apart. In one embodiment, a liquid dispensing instrument comprises a barrel having a first end and a second end, and a cap disposed over the first end of the barrel. The barrel has a deformable arm having a fixed end affixed to the barrel and a free end, the deformable arm protruding radially away from the barrel. The free end of the deformable arm pushes the cap away from the first end of the barrel when the deformable arm is pushed radially toward the barrel.

### CROSS-REFERENCE TO RELATED APPLICATIONS

This application claims the benefit of U.S. Provisional Application No. 60/740,240, filed Nov. 29, 2005, which is hereby incorporated by reference in its entirety.

### BACKGROUND

1. Field of the Invention

The present invention relates generally to containers having caps or lids and, in particular, to a liquid dispensing instrument, such as a marker assembly or writing instrument, that provides a convenient mechanism for removing a cap.

2. Background of the Invention

A conventional marker is a cylindrical tool with a nib (i.e., a liquid dispensing or marking portion) protruding from the distal end. Ink is stored within the cylindrical body of the marker. A user grips the marker by the cylindrical body and applies the nib to a surface to dispense ink onto that surface.

A removable covering or cap fitted onto the marker protects the nib from drying out. A conventional cap is removed from a marker by a gripping and pulling action. Often, this gripping and pulling action is difficult, particularly for children or adults who lack the strength to separate the pieces and/or the cognitive abilities to understand the mechanics. For example, a child's hands may repeatedly slip off the ends of a marker because the child lacks gripping strength or an understanding of the need to squeeze, twist, or bend the cap while pulling.

### BRIEF SUMMARY OF THE INVENTION

A liquid dispensing instrument according to the present invention includes a barrel, a release mechanism, and a cap. The release mechanism can comprise a deformable arm affixed to the barrel or the cap, for pushing the cap and barrel apart. The deformable arm can be integrally formed with the barrel or cap, or can be part of a plastic sleeve fitted around the barrel or cap. In a preferred embodiment, the barrel includes a recessed exterior surface for receiving a sleeve having the deformable arm. The release mechanism mechanically releases a cap from the barrel by pushing against a bottom edge of the cap (in the case when the deformable arm is affixed to the barrel) or against a part of the barrel (in the case when the deformable arm is affixed to the cap), when an arm of the release mechanism is pressed. In a preferred embodiment of the present invention, the release mechanism is applied to a marker assembly, although the release mechanism can be applied to any container having a lid or cap.

### BRIEF DESCRIPTION OF THE DRAWINGS

FIG. 1 is a schematic diagram showing an exploded isometric view of a liquid dispensing instrument, according to an embodiment of the present invention.

FIG. 2 is a schematic diagram of a sleeve in an as-molded position, according to an embodiment of the present invention.

FIG. 3 is a schematic diagram of a partial cross-sectional view of a sleeve in an in-use position, according to an embodiment of the present invention.

FIG. 4 is a schematic diagram of a barrel with portions of varying diameters, according to an embodiment of the present invention.

FIG. 5 is a schematic diagram of a cross-sectional view of a portion of a barrel that receives a nib, according to an embodiment of the present invention.

FIG. 6 is a schematic diagram of a liquid dispensing instrument having a barrel with a constant outer diameter, according to an alternative embodiment of the present invention.

FIG. 7 is a schematic diagram of a liquid dispensing instrument having a deformable arm extending from its end plug, according to an alternative embodiment of the present invention.

FIG. 8 is a schematic diagram of a cap with a deformable arm, according to an alternative embodiment of the present invention.

### DETAILED DESCRIPTION OF THE INVENTION

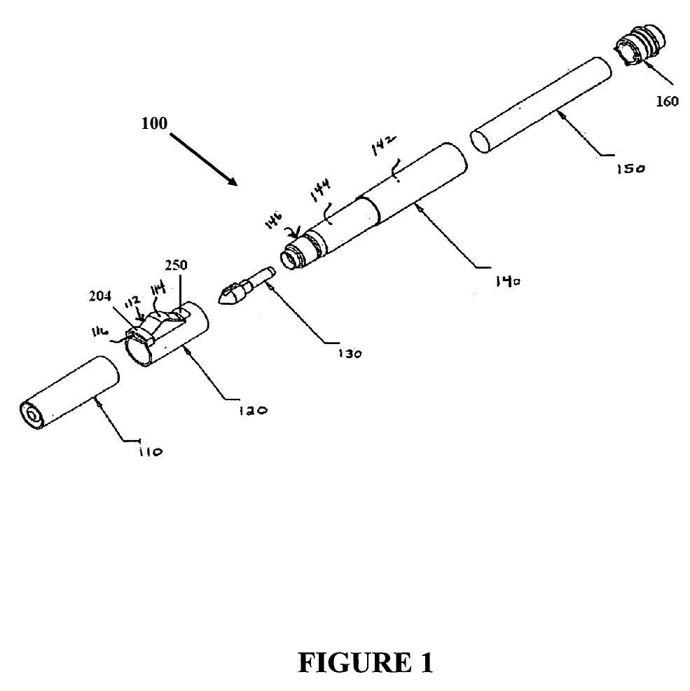

FIG. 1 illustrates an exploded isometric view of a liquid dispensing instrument according to an embodiment of the present invention, which in this example is a marker assembly 100. As shown, marker assembly 100 includes a cap 110, a sleeve 120, a nib 130, a barrel 140, a filter 150, and an end plug 160.

Barrel 140 defines an interior compartment for holding a filter 150 wetted with an ink or other liquid. An end plug 160 plugs one distal end of barrel 140, securing filter 150 within barrel 140. Nib 130 fits into an opposite, second distal end of barrel 140 and is in fluid communication with filter 150 to deposit an ink or other liquid from filter 150 onto a surface.

An exterior surface of barrel 140 includes a first portion 142, a second portion 144, and a third portion 146. The first portion 142 comprises a full diameter exterior surface of barrel 140 adjacent to end plug 160. The second portion 144, which has an outer diameter smaller than first portion 120, comprises a recessed exterior surface of barrel 140 for receiving sleeve 120. The sleeve 120 preferably fits around the recessed second portion of barrel 140 such that the exterior surface of marker assembly 100 is substantially flush at the junction between sleeve 120 and the first portion 142 of barrel 140. Sleeve 120 can be affixed to the barrel 140 by, for example, a friction fit or adhesive.

The third portion 146, from which nib 130 extends, comprises a grooved and/or ridged exterior surface for receiving cap 110. An interior surface of cap 110 has a complementary groove and/or ridge for mating to the third portion 146 of barrel 140. Cap 110 covers and protects nib 130.

Sleeve 120 includes an arm 112 for conveniently releasing cap 110 from barrel 140. In a preferred embodiment, force is applied to pressure point 114 to deform arm 112, causing tab 116 of arm 112 to press against a distal end of cap 110, thereby pushing cap 110 away from barrel 140. The arm is preferably made of a material that has memory, so that the arm returns to its original shape after the force is removed.

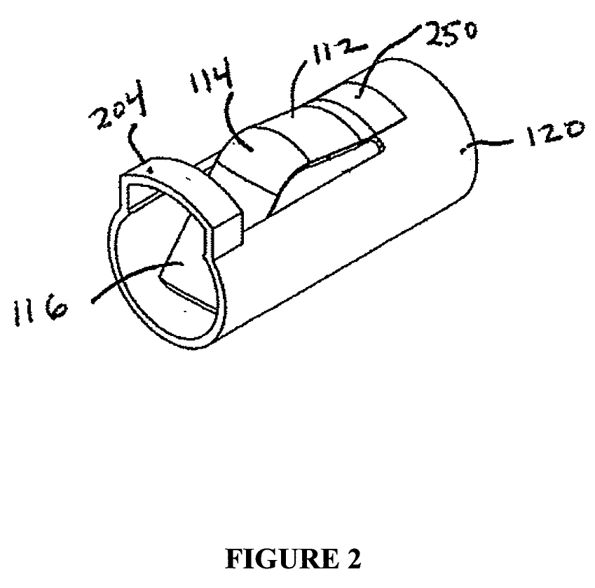

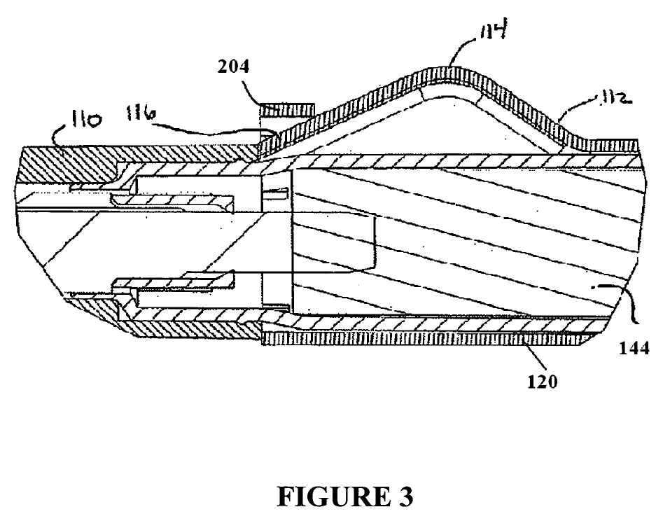

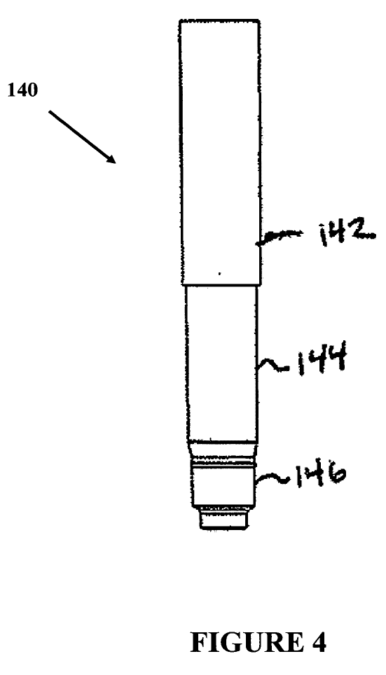

FIGS. 2 and 3 show the sleeve in an as-molded position and an in-use position, respectively, according to an embodiment of the present invention. Sleeve 120 includes an arm 112 and an arm guide 204. In a preferred embodiment, arm is generally V-shaped with its elbow protruding a maximum distance from the barrel. Arm guide 204 is preferably an arch formed adjacent a distal end of the sleeve 120 extending radially outward from sleeve 120. Arm 112 extends along an axial direction of sleeve 120 and flexes in a radial direction with respect to sleeve 120. In particular, a first end 250 of arm 112 attaches to sleeve 120 and a second end of arm 112 comprising tab 116 is positioned below (or radially inward of) arm guide 204.

Arm 112 is flexible and includes tab 116 at its free end and a pressure point 114 at its elbow. In the as-molded position shown in FIG. 2, tab 116 extends radially inward of sleeve 120. However, in the in-use position shown in FIG. 3, barrel 140 presses arm 112 radially outward so that an end of tab 116 is aligned with the second portion 144 of barrel 140. In this configuration, an end of tab 116 abuts a bottom edge of cap 110. When arm 112 is pressed at pressure point 114, tab 116 presses against the bottom edge of cap 110, thereby pushing cap 110 away from barrel 140 to assist in removing the cap 110.

As shown in FIG. 3, arm guide 204 holds arm 112 against barrel 140 and tab 116 against cap 110 when the marker is not in use. When arm 112 is pressed, arm guide 204 also prevents arm 112 from slipping up and over the exterior surface of cap 110. As the arm 112 deforms, arm 112 slides against arm guide 204 and is held in place by arm guide 204, to apply force directly to the end of cap 110. As shown in FIG. 3, barrel 140 can also be tapered proximate to the end of cap 110 to direct tab 116 of arm 112 against, or even underneath, the end of cap 110.

In an alternative embodiment, an end of tab 116 positioned below arm guide 204 is aligned with end 250 of arm 112 (i.e., at the same radial distance from the center of sleeve 120) in both the as-molded and in-use positions.

Barrel 140, sleeve 120, and cap 110 are constructed of, for example, plastic, including thermoplastic and thermoset plastic, metal, natural materials, or similar materials. Barrel 140 may be translucent or opaque. Barrel 140 includes a first portion 142, a second portion 144, and a third portion 146. The first portion 142 is full diameter and is adjacent to end plug 160. An interior surface of the first portion contains grooves or ridges for receiving end plug 160. The grooves or ridges are complementary to grooves or ridges on an exterior surface of end plug 160. In an alternative embodiment, an interior surface of barrel 140 does not have any grooves or ridges for securing end plug 160 into barrel 140, and instead uses another means of attachment, such as a friction fit or a fixative or adhesive.

The second portion 144 comprises a recessed exterior surface of barrel 140 for receiving sleeve 120. Particularly, the outer diameter of the second portion 144 is smaller than the outer diameter of the first portion 142. The outer diameter of the second portion 144 fits within the sleeve 120, and an outer diameter of sleeve 120 preferably equals an outer diameter of the first portion 142.

In a preferred embodiment, an inner diameter of the second portion 144 is smaller than an inner diameter of the first portion 142. However, in an alternative embodiment, the inner diameters of the first portion 142 and the second portion 144 are equal.

The third portion 146 is a grooved and/or ridged exterior surface for receiving cap 110. The third portion 146 preferably includes at least one exterior notch for mating with cap 110. In another embodiment, the third portion 146 includes multiple notches or grooved surfaces for receiving cap 110.

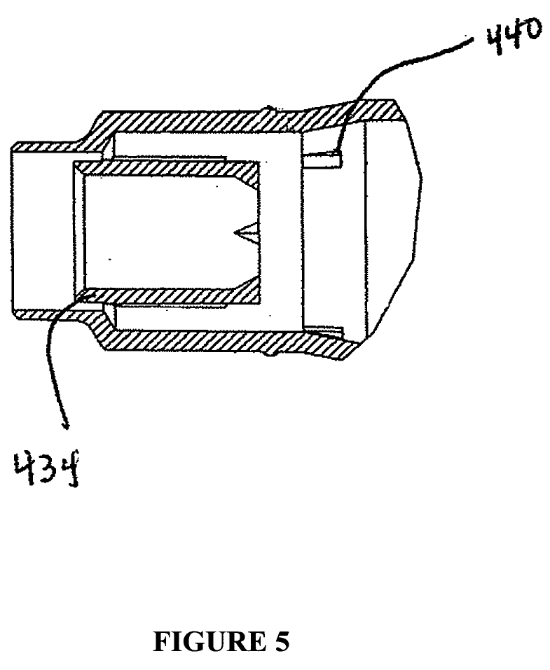

As shown in the cross-sectional view of FIG. 5, an interior surface of the third portion 146 contains a nib support 434 and a filter stop 440. Nib support 434 is a structure formed on an internal surface of barrel 140 for receiving nib 130. Nib support 434 narrows an inner diameter of the barrel to accommodate and support nib 130 within barrel 140.

The filter stop 440 provides a structure for securing filter 150 within barrel 140 while allowing an ink or other liquid to flow to nib 130. In this manner, one end of filter 150 is secured within the barrel 140 by end plug 160 and the opposite end of filter 150 is secured within the barrel 140 by the filter stop 440.

Filter 150 is inserted into barrel 140 and wetted with an ink or other liquid for marking a surface. Filter 150 is shown as a filter that is substantially the length of barrel 140. However, the skilled artisan will recognize that filter 150 may have a substantially shorter length than barrel 140.

Filter 150 is saturated with an ink or other liquid to provide that ink or other liquid to nib 130. In a preferred embodiment, one end of nib 130 is inserted into filter 150 to receive the ink or other liquid from the filter 150.

Ink can include waterbase ink, highlighter ink, permanent ink, ink visible only under ultra-violet light, waterproof ink, or any other type of ink. Some exemplary and non-limiting colors of ink include black, red, blue, green, brown, purple, pink, orange, and yellow. Ink may be suitable for general purpose marking on porous and/or non-porous surfaces. It may be created for various levels of durability and for application on various surfaces. In addition to ink, other liquids can be used, which cooperate with suitable substrates to provide writing or other artistic effects. For example, the liquid could be water, intended for substrates activated by water.

As shown in FIG. 1, end plug 160 can contain various grooves or ridges around the diameter of its exterior surface for mating to an interior surface of barrel 140. However, one of ordinary skill in the art will appreciate that end plug 160 can have a smooth exterior surface and couple to an interior surface of barrel 140 by other means, such as a friction fit or an adhesive.

In a preferred embodiment, a bottom surface of end plug 160 that is inserted into barrel 140 includes notches that mate to a structure within barrel 140.

In a preferred embodiment, a color of the cap 110, sleeve 120, and/or end plug 160 matches a color of the ink in barrel 140.

As shown in FIG. 1, nib 130 includes an ink or other liquid receiving portion and an ink or other liquid applying portion. The ink or other liquid receiving portion funnels ink or other liquid from filter 150 to ink the applying portion.

Nib 130 can comprise a bullet nib, a chisel nib, a cylindrical nib, or any other shaped nib. Nib 130 may be of any size. In a preferred embodiment, nib 130 is a felt nib. However, nib 130 is not limited to any particular material or fabric. For example, nib 130 may be constructed of plastic, silicon, or metal.

In a preferred embodiment, nib 130 includes a groove or ridge on an exterior surface that mates to a complementary groove or ridge formed on an interior surface of barrel 140 to align the nib within the marker assembly.

Cap 110 can include ridges or grooves on an interior face for mating with barrel 140. However, in an alternative embodiment, cap 110 has a smooth interior that fits onto barrel 140 by a friction fit. In a preferred embodiment, cap 110 matches a color of ink within barrel 140. However, the present invention is not limited to any particular type of cap 110 or color scheme for cap 110.

Although the embodiment of FIG. 1 depicts arm 112 formed as a structure (sleeve 120) separate from barrel 140, an alternative embodiment of the present invention provides a monolithic construction, with an arm integrally formed with the barrel. In addition, the arm guide can be integrally formed with the barrel. Thus, the present invention can provide a barrel comprising a sleeve attached to a barrel body or a barrel integrally formed with the arm and the arm guide.

In an alternative embodiment, cap 110 and arm 112 include complementary engagement structures, such as a notch on the arm 112 and a projection on the cap 110. In this manner, when arm 112 is pressed, it engages the corresponding structure of cap 110 and does not slip over the exterior surface of cap 110. FIG. 3 shows one example of an engagement structure, in which tab 116 has a wedge shape at its end that mates with and pushes the rim of cap 110. As another example, the exterior surface of cap 110 could have a projection (e.g., a post or hook) that engages the free end of arm 112. In this manner, the diameter of the cap 110 and barrel 140 could be equal, and the sleeve 120 could be slipped over and affixed to the barrel 140. In one embodiment, an existing marker could be retrofitted with a sleeve over the barrel and a projection on the cap to provide the release mechanism of the present invention.

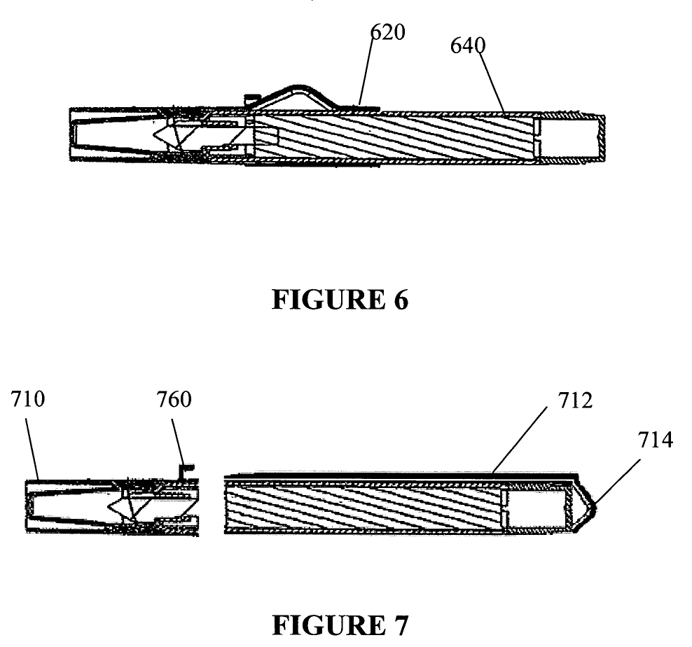

In another embodiment shown in FIG. 6, barrel 640 has a constant outer diameter. The sleeve 620 is fitted around the barrel 640 by complementary grooves or ridges on the sleeve 620 and the barrel 640 or by other means of attachment, such as a friction fit or an adhesive. The deformable arm of sleeve 620 can push against, for example, the rim of the cap or a projection extending radially from the cap.

In an alternative embodiment as shown in FIG. 7, an arm 712 extends from the end plug to the liquid dispensing side of the barrel. The arm 712 projects above the end plug to form an elbow or a pressure point 714 on top of the end plug. When pressure is applied to the pressure point 714 longitudinally in the direction of the cap 710, the arm 712 deforms and slides along the length of the barrel to push the cap 710 away from the barrel. Although not shown, the barrel could have one or more arm guides to guide the sliding arm against the cap. In addition, the cap 710 may further include a projection 760 shaped like a hook so that the arm 712 may push the projection 760 instead of an edge of the cap 710.

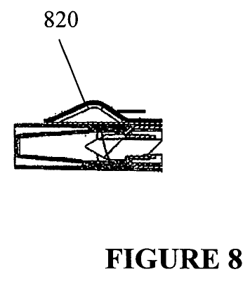

In another alternative embodiment of the present invention, a deformable arm is affixed to the cap, rather than to the barrel, as shown in FIG. 8. For example, a sleeve 820 with a deformable arm could be affixed to a cap, such as cap 110 (FIG. 1). In this configuration, the free end of the deformable arm contacts the barrel. When pressure is applied to the pressure point of the deformable arm, the arm presses against the barrel, thereby pushing the barrel away from the cap. As an alternative to a sleeve, the deformable arm could be integrally formed with the cap. In this alternative embodiment, locating the deformable arm on the cap enables the use of conventional barrels, including the ability to retrofit conventional markers by replacing the conventional caps of those markers with caps having deformable arms or by modifying the conventional caps (e.g., adding a sleeve with a deformable arm) to include a deformable arm.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. In addition, notwithstanding the particular benefits of applying the invention to a liquid dispensing instrument or marker assembly, the invention should be considered broadly applicable to any container having a lid or cap (e.g., glue sticks, cosmetic containers, and writing instruments other than markers). The scope of the invention is to be defined only by the claims, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A liquid dispensing instrument comprising:
a barrel having
a first end and a second end, the first end comprising a liquid dispensing portion, and
a deformable arm having a fixed end affixed to the barrel and a free end, the deformable arm protruding away from the barrel; and
a cap disposed over the first end of the barrel, the free end of the deformable arm pushing the cap away from the first end of the barrel when the deformable arm is pushed toward the barrel.

2. The instrument of claim 1, the barrel further comprising an arm guide, the arm disposed radially between the arm guide and the barrel, and the arm contacting the arm guide when the deformable arm is pushed radially toward the barrel.

3. The instrument of claim 2, wherein before the arm is pushed, the arm guide contacts the arm and holds the arm against the barrel.

4. The instrument of claim 1, the cap comprising a closed end and an open end, the open end defining a rim, and the free end of the deformable arm pushing the rim in a direction longitudinal to the barrel.

5. The instrument of claim 4, the barrel being tapered radially inward proximate to the rim of the cap.

6. The instrument of claim 1, the barrel comprising:
a body; and
a sleeve disposed over the body, the arm formed as part of the sleeve.

7. The instrument of claim 6, the body comprising a first portion of a first outer diameter and a second portion of a second outer diameter smaller than the first outer diameter, the sleeve disposed within the second portion and having an inner diameter approximately equal to the second outer diameter and an outer diameter approximately equal to the first outer diameter.

8. The instrument of claim 7, the sleeve affixed to the body by an adhesive.

9. The instrument of claim 6, the instrument dispensing an ink, and the sleeve having a color matching a color of the ink.

10. The instrument of claim 1, the arm being integrally molded with the barrel.

11. The instrument of claim 1, the first end of the barrel holding a nib extending from the barrel, the nib wetted with ink, and the cap covering the nib.

12. The instrument of claim 1, the cap having a projection projecting radially away from the exterior surface of the cap, and the free end of the arm pushing against the projection.

13. The instrument of claim 12, the projection comprising a hook.

14. The instrument of claim 1, the deformable arm comprising a V-shape having an elbow, with the elbow of the V-shape protruding a maximum distance radially away from the barrel, and wherein the arm is pushed at the elbow radially inward.

15. The instrument of claim 1, wherein the barrel is translucent.

16. The instrument of claim 1, the barrel comprising plastic.

17. The instrument of claim 1, further comprising:
an end plug over the second end of the barrel;
a filter contained within the barrel, the filter wetted with a liquid; and
a nib held within and extending from the first end of the barrel, the nib in fluid communication with the filter.

18. The instrument of claim 17, the arm extending from and protruding away from the end plug, and extending alongside the barrel to the first end of the barrel.

19. The instrument of claim 1, wherein the deformable arm is made of a material having memory such that after the deformable arm is pushed and released, it returns to its original shape.

20. A container comprising:
a body defining a longitudinal axis, the body having
a first end and a closed second end, the first end comprising a dispensing portion, and
a deformable arm having a fixed end affixed to the body and a free end, the deformable arm protruding radially away from the body; and
a cap disposed over the first end of the body, the free end of the deformable arm pushing the cap longitudinally away from the first end of the body when the deformable arm is pushed radially toward the body.

21. The container of claim 20, the body comprising a cylinder.

22. A liquid dispensing instrument comprising:
a barrel having a first end and a second end, the first end comprising a liquid dispensing portion; and
a cap disposed over the first end of the barrel, the cap having a deformable arm, the deformable arm having a fixed end affixed to the cap and a free end, the deformable arm protruding radially away from the cap, and the free end of the deformable arm pushing the barrel away from the cap when the deformable arm is pushed radially toward the cap.
